(19) United States
(12) Patent Application Publication
(10) Pub. No.: US 2012/0228550 A1
(43) Pub. Date: Sep. 13, 2012

(54) NITRIDE PHOSPHOR, REACTION MIXTURE AND METHOD PRODUCTION AND LIGHT EMITTING DEVICE COMPRISING SUCH A PHOSPHOR

(75) Inventors: Chang Whan Won, Daejeon (KR); Hyung II Won, Daejeon (KR); Hyung Suk Won, Daejeon (KR); Hayk Nersisyan, Daejeon (KR)

(73) Assignee: ELLIM ADVANCED MATERIALS CO., LTD., Daejeon (KR)

(21) Appl. No.: 13/512,238

(22) PCT Filed: Oct. 19, 2010
(86) PCT No.: PCT/KR10/07148

§ 371 Date: May 25, 2012

(30) Foreign Application Priority Data
May 25, 2010 (KR) 10-2010-0048585

(51) Int. Cl. C09K 11/85

(52) U.S. Cl. 252/301.4 H

(57) ABSTRACT

Provided are a method for preparing a rare-earth doped alkaline-earth silicon nitride phosphor powder having the composition of Me₂₋ₓRₓSi₅N_{8-y}F_{3y} (0<x<1.0, 0≦y<0.5) within seconds at ambient temperature; the nitride phosphor prepared therefrom; and a light emitting device comprising the phosphor.

Such silicon nitride based phosphors having small particle size, large surface area and improved chemical properties can strongly absorb UV and blue light and efficiently convert it into orange-red light, so that they can be used as an effective phosphor to form a smooth layer without sedimentation in a LED package, and as light sources and displays. Especially for applying the fine particles to a LED package, cost reduction can be achieved with respect to the weight ratio.

### TECHNICAL FIELD

The present invention relates to a method for preparing rare-earth doped alkaline-earth silicon nitride phosphor powder having the composition of Me₂₋ₓRₓSi₅N₈ (0<x<1.0) within a few seconds at ambient temperature, and to the phosphor powder prepared therefrom.

In such a method for preparing a rare-earth doped alkaline-earth silicon nitride phosphor powder, a fluorine source (FS) containing a small amount of inorganic fluoride salt can be additionally incorporated to the reaction mixture, so that a rare-earth doped alkaline-earth silicon nitride phosphor powder to which fluorine has been incorporated, Me₂₋ₓRₓSi₅N_{8-y}F_{3y} (0<x<1.0, 0<y<0.5) can be obtained, and the phosphor would be improved physical and optical properties.

Such silicon nitride based phosphor prepared according to the invention, having small particle size, large surface area and improved chemical properties, can strongly absorb UV and blue light and efficiently convert it into orange-red light, and therefore they can be used as an effective phosphor to form a smooth layer without sedimentation in a LED package, and as light sources and displays. Especially for applying the fine particles to a LED package, cost reduction can be achieved with respect to the weight ratio.

Further, the present invention relates to a light emitting device having modified optical properties, which comprises the phosphor described above.

### BACKGROUND ART

White LED is highly expected as one of the most promising eco-friendly light sources, with much less energy consumption than conventional light sources. In most white LED devices, phosphors doped with rare earth elements such as Ce⁺³/Eu⁺² are excited by a blue-InGaN LED chip and emit longer-wavelength light, and the mixed light results in emission of white light, in principle.

Although the combination of a blue-InGaN LED chip and a yellow phosphor (Y,Ce)₃Al₅O₁₂ has been the most popular white light source material in the market, the share of red phosphor has been steadily increasing for high colour rendering index and good colour reproducibility for general lighting, backlights for LCD in cell phones and flat panel displays (FPD).

In response to this, many novel ternary or more complex nitride phosphors have recently been developed as alternatives to known phosphors, such as silicate, phosphate, aluminate, borate, sulfide, and oxysulfide phosphors. In particular, recently developed silicon nitride-based multi-component nitride compounds exhibit high performance as phosphors.

In EP 1104799 A1, disclosed is a method for preparing red-emitting M₂Si₅N₈ (M=Ca, Sr, Ba) nitride phosphors.

According to the method, alkaline-earth nitrides and europium nitrides were firstly prepared by direct nitridation of metals under nitrogen atmosphere at 550˜800° C. for 8˜16 h in a tube furnace. Then the alkaline-earth nitrides were mixed with a-Si₃N₄ and EuNₓ, and the mixture was filled into molybdenum crucible and heat-treated under flowing of 90% N₂ and 10% H₂ atmosphere by maintaining temperature condition of 1300˜1400° C. for reaction duration of 12 to 16 hours, to produce polycrystalline M₂ₓEuₓSi₅N₈ (0≦x≦0.2 for M=Ca, 0≦x≦2.0 for M=Sr, Ba) phosphor powder.

However the method disclosed by EP 1104799 A1, which firstly prepares alkaline-earth nitrides and rare-earth nitrides, is disadvantageous because of difficulties in the process for preparation and high cost of said nitrides. Further, the method involves problems of storage of the raw materials from air and moisture. Moreover, conversion efficiency of the phosphors obtained by said method is not satisfactory, thereby requiring modification.

Japanese Patent Laid-Open Publication No. 2003-515665 discloses phosphors represented by general formula of MₓSi_{y}N_{z}:Eu⁺² (wherein, M is one or more alkaline earth metal elements selected from the group consisting of Ca, Sr and Ba, and x, y, and z are numbers satisfying z=2/3x+4/3y). Such red-light emitting nitride phosphors are synthesized by nitridation of alkaline earth metal and then mixing the obtained alkaline earth nitrides with silicon nitride, or by heating alkaline earth imide and silicon imide as raw materials under nitrogen or argon atmosphere. This method also involves all disadvantages of the method described in EP 1104 799 A1.

U.S. Patent Publication No. 2007/0040152 describes phosphors having the composition of M₂Si₅N₈, MSi₇N₁₀, MSiN₂ or MeAlSiN₃ (wherein, M is Mg, Ca, Sr, Ba, or the like), substantially without oxygen. These are disadvantageous, however, because the process uses nitrides of alkaline-earth metals and rare earth metals as starting materials, involving difficulties in the preparation process, high production cost, and uneasy handling.

These factors conspire to make silicon nitride-based phosphors difficult to produce industrially. It is recognized as stated that: “the commercially available silicon nitride-based phosphors have following problems: (1) low purity due to the presence of impurity oxygen, (2) low material performance of a phosphor caused by the low purity; 3) high production cost”. Thus, those compounds are reported to have poor optical properties.

Furthermore, raw materials of the nitride phosphors described in the literature above are reported to have low reactivity in powder form. Thus, the raw materials must be heated at high temperature (1200-1600° C.) for a long period (at least 10 hours) in order to promote the solid state reaction between the particles of the raw materials.

As a result, the synthesized phosphor consists of large agglomerates of very large sized grains (from 3 to 15 μm). Such agglomerated powder should be pulverized into separated particles, in order to make a form suitable for its intended purposes as phosphor.

In order to achieve above purposes, a long time milling is required, but this may cause significant deterioration of the light emission intensity.

A method for preparing phosphors containing Eu²⁺ by employing the strontium acetate both as the alkaline earth source and a reducing agent has been reported by Xianqing Piao . [Journal of Luminescence 130 (2010) 812].

Stoichiometric amounts of SrCO₃ and Sr(CH₃CO₂)₂ are employed (1:1); Si₃N₄ and Eu₂O₃ are mixed thereto, and the resultant mixture is incorporated to a ZrB₂ heater, and heated in a furnace at a radiofrequency range of 8.0-9.5 kHz under nitrogen atmosphere to provide the phosphor.

Then, temperature was rapidly raised up to 1500-1600° C. at a heating rate of 300° C./min, and maintained at this temperature for 6 h to form the target phosphor. However, this method is not able to produce oxygen free nitride phosphor, thereby leading to significant deterioration of the light emission intensity. Further, the technique is not commercially applicable because of low efficiency.

It is reported by Rong-Jun Xie . (Chem. Mater., 2006, 18, 5578-5583) that Sr Si₅N₈:Eu²⁺-based red phosphors have been synthesized from a mixture containing SrCO₃, Si₃N₄ and Eu₂O₃.

The mixture of those raw materials was prepared at 1600° C. for 2 hours under N₂ atmosphere at 0.5 MPa. The final product thus produced consists of three main components: Sr₂Si₅N₈, a-Sr₂SiO₄, and b-Sr₂SiO₄. This article does not describe pure strontium-silicon nitride phosphors.

A carbothermal reduction and nitridation (CRN) method to produce Sr₂Si₅N₈:Eu⁺² phosphors based on high temperature calcination of SrO+Si₃N₄+Eu₂O₃+C mixture under nitrogen atmosphere was recently reported by Xianqing Piao.

This method cannot remove residual carbon in the phosphor, thereby significantly decreasing its absorption and emission properties. Also, complete reduction of SrO (which is thermodynamically very stable) by C would not be so realistic, even at such a high temperature.

For the reasons described above, novel and advanced methods for producing silicon nitride-based based phosphors are urgently demanded in practice.

U.S. Pat. No. 5,110,768 teaches a combustion process for producing a material having the form TBₒ, e.g. zirconium nitride (ZrN), which comprises mixing a first salt having the form TXₙ, e.g. zirconium tetrachloride (ZrCl₄) and a second salt having the form AₘB, e.g. lithium nitride (Li₃N), and subsequent ignition.

It is reported that the process can give zirconium nitride (ZrN) by igniting the first salt (ZrCl₄) and the second salt (Li₃N), but with additional formation of nAX and (n/m-o)B, e.g. 4LiC1 and (1/6)N₂, respectively.

According to the disclosure, T is selected from the group consisting of transition metal such as zirconium and tetrelides such as carbon, silicon, tin and lead; X is selected from the halide groups; A is selected from alkali metals such as lithium, sodium and potassium, and alkaline earth metals such as calcium, magnesium, strontium and barium; B is selected from the group consisting of pnictides such as nitrogen, phosphorus, arsenic and antimony, and tetralides such as carbon, silicon, germanium and tin; and m and n are appropriate integers. This document does not describe, however, silicon nitrides nor alkaline earth nitrides, not to mention any nitride-based phosphor containing alkaline-earth metal.

U.S. Pat. No. 4,944,930 teaches a combustion process for the preparation of alpha-silicon nitrides. Preparation of alpha-silicon nitride comprises the steps of mixing silicon powder with an alkali metal azide such as sodium azide (NaN₃), forming the mixture into any desired shape, and loading it into a quartz crucible, and igniting it by using an ignition pellet in a combustion chamber under nitrogen.

Specifically, in the process above, silicon powder (Si) or silicon dioxide (SiO₂) is mixed with metal or metal oxide, a small amount of an alkali metal azide such as sodium azide (NaN₃) is additionally incorporated thereto, and the reaction mixture is transferred into a combustion chamber. After pressurizing the combustion chamber with nitrogen, the reaction mixture is ignited to carry out combustion process. Then alpha-silicon nitride is isolated as reaction product. However, the prior art does not describe nitride phosphors containing silicon, nor those containing alkaline earth metal.

The inventors of the above-described patent did not investigated a synthetic process by combustion to prepare phosphors containing alkaline-earth and/or aluminum nitride and silicon nitride, but some of the inventors have just studied self-propagation high-temperature synthesis (SHS).

In these processes, Ba₂₋ₓEuₓSi₅ and Ca₁₋ₓEuₓAlSi alloy powder can be prepared by arc-melting technique from the precursors under argon atmosphere. Then the alloy powder can be heat treated at a temperature of 1450-1550° C. under nitrogen atmosphere to produce nitride phosphor as powder. It is obvious, however, the processes described are solid-state reactions, but cannot be considered as a synthetic process for phosphors via a combustion process.

### DISCLOSURE

### Technical Problem

Accordingly, it is the first object of the present invention to solve the above mentioned problems and to provide highly crystalline phosphors by incorporating fluorine therein.

The second object of the present invention is to provide a process for stably preparing phosphors without any external heat source, by using reaction mixture with high cost efficiency and easy handling.

The third object of the present invention is to provide a rapid process to prepare highly crystalline silicon nitride based phosphor powder containing alkaline-earth metal, with small particle size.

The fourth object of the invention is to provide light emitting devices (LED) comprising the phosphors according to the present invention.

### Technical Solution

The present invention relates to a process for preparing rare-earth doped alkaline-earth silicon nitride phosphor powder in a few seconds at ambient temperature, the phosphor powder thus prepared, and light emitting devices comprising the phosphor.

Specifically, the invention relates to nitride phosphor having the chemical formula:

Me₂₋ₓRₓSi₅N_{8-y}F_{3y}

wherein, Me represents alkaline earth metal, R represents rare earth metal, Si represents silicon element, and N represents nitrogen element, x and y are numbers satisfying 0<x<1 and 0≦y<0.5.

Preferably, numbers x and y satisfy 0<x<1.0 and 0<y<0.5.

More preferably, numbers x and y satisfy 0<x<0.5 and 0<y<0.3.

The nitride phosphor powder is characterized by mean particle size of not more than 3 μm, preferably not more than 2.5 μm.

The process for preparing a nitride phosphor according the invention comprises
a) providing a reaction mixture comprising rare-earth metal compound (RC), alkaline-earth metal salt (MX₂), alkali metal azide (AN₃), silicon source (Si) and nitrogen (N);
b) carrying out a combustion process of the reaction mixture in a high pressure reactor under nitrogen atmosphere;
c) isolating the nitride phosphor produced through the combustion process and cleanse it.

Cleansing may be carried out by using acid such as HCl, HNO₃, H₂SO₄ and HF.

In the first stage, reactant raw materials are selected. First reactant material is alkaline earth metal salt (MX₂), which consists of alkaline earth metal and halogenide ion. Preferable halogenide ion is chloride ion. Alkaline earth metal salt (MX₂) is preferably selected from a group consisting of MgF₂, CaF₂, BaF₂, SrF₂, MgCl₂, CaCl₂, BaCl₂, SrCl₂, MgBr₂, CaBr₂, BaBr₂, SrBr₂, MgI₂, CaI₂, BaI₂ and SrI₂. Molar proportion of alkaline earth metal salt (MX₂) may be from 2 to 3.5 on the basis of silicon source (Si). Usually, the alkaline earth metal salts are commercially available, relatively easy to handle and inexpensive as compared to alkaline earth metal nitrides.

With respect to generally available strontium chloride, dehydration stage may be required, since, for example, strontium chloride contains crystalline water (SrCl₂,6H₂O). Dehydration can be carried out by heating strontium chloride containing crystalline water (SrCl₂.6H₂O) at 400˜500° C. for several hours.

In the reaction mixture, the second component is alkali metal azide (AN₃), which has two key functions: first, it is employed as a reductant for alkaline-earth metal salt; second, it serves as a nitrogen atom donor during the combustion process.

Preferable alkali metal azide (AN₃) is selected from NaN₃, KN₃ and LiN₃, and the molar ratio of alkaline earth metal salt (MX₂) and alkali metal azide (AN₃) may be from 2:4 to 3.5:7.

In the reaction mixture, the third component is a silicon source (Si), which is used as silicon powder. The particle size may be from 0.5 to 100 μm, preferably from 5 to 20 μm.

The process using silicon powder gives economic advantages from the aspect of cost as compared to conventional processes (including above-mentioned patents) using silicon nitride.

Nitridation of silicon is highly exothermic, and the reaction heat generated by this stage is critical to carry out the process for preparing silicon nitride-based phosphor in self-sustaining combustion mode at ambient temperature, according to the present invention.

In the reaction mixture, the fourth component is rare earth compound (RC), which may be rare earth metal salt. Preferable rare earth metal salt may be one containing metal selected from Y, La, Ce, Pr, Nd, Sm, Eu, Gd, Tb, Dy, Ho, Er and Lu; more preferably, it is a europium salt. As the rare earth metal salt containing europium, preferable is EuCl₂, EuF₃ or Eu₂O₂. The amount of rare earth compound (RC) to be used may be from 0.02 to 1 mole based on alkaline earth metal.

In the reaction mixture, the fifth component is a fluorine source (FS).

During the process of providing the reaction mixture, fluorine source containing inorganic fluoride salt is additionally incorporated to give nitride phosphor containing fluorine, having the composition of Me₂₋ₓRₓSi₅N_{8-y}F_{3y} (0<x<1, 0<y<0.5), which shows much enhanced optical properties.

More preferably, composition of the fluorine-containing nitride phosphor would be Me₂₋ₓRₓSi₅N_{8-y}F_{3y} (0<x<0.5, 0<y<0.3).

The fluorine source (FS) containing inorganic fluoride salt may be a fluoride with one or more element(s) selected from Group 1, 2 and 3 of the Periodic Table of Elements; being selected from NaF, Na₂SiF₆, CaF₂, NH₄F and AlF₂. The amount of the fluorine source (FS) containing inorganic fluoride salt may be from 0.01˜0.3 mole on the basis of 5 moles of silicon (Si).

All raw materials used for the present invention are commercially available, easy to handle and cost-effective, so that the process according to the invention provides economic advantage. Since the process according to the invention is exothermic during the combustion process, it is advantageous in that no external heat source is required during the synthesis of the nitride phosphor.

The second stage of the process for preparing the nitride phosphor according to the invention comprises filling the reaction mixture in a reaction cup; putting it into a high pressure reactor; and carrying out combustion process therein under nitrogen atmosphere. In the stage, a reaction cup of desired shape (such as cylindrical or rectangular shape) are prepared in order to prepare nitride phosphor via combustion process, and the reaction mixture is filled into the reaction cup and subjected to combustion process at ambient temperature and under nitrogen gas pressure. The pressure condition of nitrogen in the reaction vessel may be from 0.5 to 10 MPa, preferably from 2.0 to 5.0 MPa.

The reaction mixture according to the invention can be prepared by simply mixing the precursor powders. Mixing of any type conventionally used can be carried out, but mixing by a ball-mill is preferable for intimate and rapid mixing. A ball-mill using a polymer bottle and ceramic balls can afford rapid and intimate mixing of the raw materials. The reaction mixture can be easily separated from the ceramic balls using a 200-500 μm sized metallic sieve.

The reaction mixture obtained by mixing by a ball-mill, or the like, can be formed as a pellet after filling it into a cylindrical or rectangular cup. The cup can be made of different materials, such as paper, metal, quartz, etc. Density of the pellet may be from 0.7 to 2.0 g/cm³, preferably from 0.9 to 1.2 g/cm³.

The pellet made of the reaction mixture can be ignited by a heat source (due to resistance of metal wire) to initiate combustion process. Density of the pellet may be from 0.7 to 2.0 g/cm³, preferably from 0.9 to 1.2 g/cm³.

The combustion process in the second stage can be carried out at a temperature of 1000˜2000° C., preferably of 1100˜1700° C. within a reaction period of 1˜30 seconds.

Since the combustion process of the present invention is carried out under high pressure condition, a high pressure reactor is needed. The reaction must be carried out under nitrogen atmosphere. The reaction pressure of nitrogen according to the invention is from 0.5 to 10 MPa, preferably from 2.0 to 5.0 MPa.

Typical combustion process is carried out after transporting the reaction cup into the high pressure reactor, and igniting it by means of a heat source such as a nickel-chrome filament system. Since the combustion process is self-sustaining, no further heat source is needed once the reaction is initiated by ignition, and the reaction propagates along the reaction material at a speed of 0.1˜0.5 cm/sec.

As observing the reaction heat during the combustion process according to the present invention, the reaction heat from the reaction mixture, SrCl₂—NaN₃—Si—EuCl₃—Na₂SiF₆—N₂ can be inferred from the following formulas:

2SrCl₂+4NaN₃→2Sr+4NaCl(1)+Q₁ Q₁=20.25 kcal (1)

2Sr+4Si→2SrSi₂+Q₂ Q₂=10 kcal (2)

EuCl₃+3NaN₃→EuN+3NaCl+4N₂+Q₃ Q₃=10 kcal (3)

Na₂SiF₆→2NaF+SiF₄+Q₄ Q₄=20 kcal (4)

2SrSi₂+EuN+SiF₄+N₂→Sr₂₋ₓRₓSi₅N_{8-y}F_{3y} Q₃=177.7 kcal/mole (5)

The reaction formulas given above clearly demonstrate that the combustion process occurs with heat release, and rapidly converts the raw materials into nitride phosphor. Also during this process, a sufficient amount of molten NaCl (about 4 mole) is formed as well (T_{melt.NaCl}=810° C.).

In the third stage of the process for preparing nitride phosphor according to the invention is cleansing stage wherein the nitride phosphor produced by the combustion process is cleansed. The stage starts with removal of surface layer of the pellet containing the products obtained from the combustion process, and grinding of remaining pellet for purification. The cleansing stage can be washed with acid-treated distilled water. The acid treatment can be carried out by any acid selected from HCl, HNO₃, H₂SO₄ and HF.

Firstly, after the combustion process, the pellet is cooled down to ambient temperature and removed from the reactor. The surface layer (1-2 mm in thickness), which has not been completely reacted, is eliminated to avoid impurities. Then, the remaining pellet is grinded, and transferred to a 1 liter beaker to cleanse off any by-products or impurities.

Preliminary purification of the combustion product is carried out by using hot distilled water to eliminate NaCl (by-product). Then, other impurities (such as unreacted alkaline earth metal) can be further removed by washing it with diluted HCl:H₂O (1:5) solution for about 1 hour. A small amount of alkali solution (such as NaOH, KOH, NH₄OH) may be also added to neutralize the final solution.

Then wet powder of the nitride phosphor is transferred to a polymer bottle and grinded for 30 to 60 minutes with distilled water, using zirconia balls.

The ratio of the nitride powder to balls is 1:(2-5), preferably about 1:3 by weight. After grinding, the phosphor powder can be separated from the balls using a 20-200 μm metal sieve.

Finally, the phosphor powder isolated as above is filtered, washed several times with distilled water, and dried at 70-90° C. for several hours.

In addition, the present invention can provide nitride phosphor having the composition of Me₂₋ₓRₓSi₅N₈ (0<x<1) with particle size of not more than 2.5 μm, or that of Me₂₋ₓRₓSi₅N_{8-y}F_{3y} (0<x<1, 0<y<0.5) with same particle size, prepared according to the process of the invention.

Nitride phosphor prepared according to the present invention has particle size of not more than 2.5 μm, preferably from 0.5 to 2.0 μm. The phosphor has highly crystalline particles with excellent stable optical properties.

Nitride phosphor powder obtained by the process as described above can be employed, after being mixed with an appropriate amount of polymer resin (in order to ensure the properties of a LED), with InGaN type material for blue light to form a light emitting device. In such a case, the phosphor according to the invention can be packaged on the surface of a light emitting device comprising UV-blue light source.

Since the LED (light emitting device) may comprise a phosphor selected from a group consisting of cerium-activated yttrium-aluminum oxides and cerium-activated yttrium-gadolinum-aluminum oxides, the phosphor according to the invention can be applied to LED's or display devices. In particular, a LED can be formed, comprising blue light discharged by InGaN type material and red light phosphor prepared according to the present invention.

LED package testing results with conventional red-emitting nitride phosphor (BR-101) and red phosphor prepared by present invention are shown in FIG. 17. The concentration of BR-101 powder in LED package was 0.5 wt %, whereas the concentration of phosphor prepared by present invention was twice lower (0.25 wt %). Here, x and y are color coordinates, CRI is color rendering index, Cd is luminous intensity (candles). As can be seen the color coordinates (x and y) of LED package with both BR-101 and prepared by present invention red-emitting phosphors are in the same level. But luminous efficiency of LED package (Cd) with red phosphor prepared by present invention (6461) is 3.5-4 wt % higher comparing to conventional one (6342).

It is recognized that such excellent properties of the phosphor according to the invention not only come from combustion process but also from the fluoride-ion contained. Specifically, it is assumed that fluoride ion serves multi-functions during the combustion process as follows:
(1) Fluoride ions induce gas-transport reactions to provide highly crystalline phosphor particles from intermediate silicon fluorides (SiF₄, SiF₂, etc.) which are highly volatile.
(2) Fluoride ion forms thermodynamically stable alkaline earth metal fluorides such as strontium fluoride (SrF₂, Tₘₑₗₜ=1470° C.), which can provide thin film on the surface of the phosphor particles to enhance the optical properties.
(3) The molten salt of fluorides (NaF, SrF₂) prepared according to the invention acts as a flux, to result in increase of conversion rate of the combustion process;
(4) Fluoride ions can diffuse into the crystal lattice of the phosphor, and partially substitute for the N⁻³ ions, thereby contributing the optical properties of the phosphor.

In the meanwhile, when the particles are fine (not more than 2.5 μm) (much smaller than the particle size of phosphor powder conventionally prepared, not less than 7˜8 μm), optical properties are sharply enhanced on the reasons that:
(1) concentration of Eu (active agent) on the particle surfaces increases (as compared to coarse particles) due to increased specific surface area, to result in higher light emitting intensity; and
(2) apparent specific gravity relatively decreases as compared to coarse particles, so that sedimentation would not occur upon being applied to a LED to result in higher luminous efficiency (twice lower amount provides similar or higher emitting intensity).

### Advantageous Effects

The nitride phosphor prepared according to the present invention shows characteristics of red light source, and can be used in combination with a blue light emitting phosphor. The phosphor of the invention is applicable to a light emitting device having high efficiency. Since the process for preparing the phosphor according to the present invention employs commercially available raw materials with low price, the invention is economically advantageous as compared to conventional processes. Especially, when being applied to a LED package by using micronized particles, the production cost can be reduced with respect to weight. Moreover, due to small size of particles, the red phosphor according to the present invention provides similar or higher emitting intensity with twice lower concentration).

In view of increasing need of red light emitting phosphors in electronics industry, a fluorine-containing nitride phosphor would be established as a useful alternative.

### DESCRIPTION OF DRAWINGS

The above and other objects, features and advantages of the present invention will become apparent from the following description of preferred embodiments given in conjunction with the accompanying drawings:

FIG. 1 shows XRD pattern of Sr_{1.95}Eu_{0.05}Si₅N₈ phosphor prepared according to Example 1.

FIG. 2 shows SEM micrograph of Sr_{1.95}Eu_{0.05}Si₅N₈ phosphor prepared according to Example 1.

FIG. 3 shows XRD pattern of Sr_{1.95}Eu_{0.05}Si₅N_{7.95}F_{0.15} phosphor prepared according to Example 2.

FIG. 4 shows SEM micrograph of Sr_{1.95}Eu_{0.05}Si₅N_{7.95}F_{0.15} phosphor prepared according to Example 2.

FIG. 5 shows XRD pattern of Sr_{1.92}Eu_{0.08}Si₅N_{7.95}F_{0.15} phosphor prepared according to Example 3.

FIG. 6 shows SEM micrograph of Sr_{1.92}Eu_{0.08}Si₅N_{7.95}F_{0.15} phosphor prepared according to Example 3.

FIG. 7 shows XRD pattern of Sr_{1.8}Eu_{0.2}Si₅N_{7.95}F_{0.15} phosphor prepared according to Example 4.

FIG. 8 shows SEM micrograph of Sr_{1.8}Eu_{0.2}Si₅N_{7.95}F_{0.15} phosphor prepared according to Example 4.

FIG. 9 shows XRD pattern of Ca_{1.95}Eu_{0.05}Si₅N_{7.95}F_{0.15} phosphor prepared according to Example 5.

FIG. 10 shows SEM micrograph of Ca_{1.95}Eu_{0.05}Si₅N_{7.95}F_{0.15} phosphor prepared according to Example 5.

FIG. 11 shows XRD pattern of Ba_{1.95}Eu_{0.05}Si₅N_{7.95}F_{0.15} phosphor prepared according to Example 6.

FIG. 12 shows SEM micrograph of Ba_{1.95}Eu_{0.05}Si₅N_{7.95}F_{0.15} phosphor prepared according to Example 6.

FIG. 13 shows LED PKG spectra of red phosphors prepared according to Examples 1-4.

FIG. 14 shows excitation spectra of red phosphors prepared according to Example 1-4.

FIG. 15 shows normalized radian flux vs wavelength (chip: 452.5-455.0 nm):

5% phosphor (Sr_{1.95}Eu_{0.05}Si₅N_{7.95}F_{0.15}YF is modified phosphor-resin complex; BR101A-YF and BR102C-YF are reference phosphor-resin complexes).

FIG. 16 shows normalized radian flux vs wavelength (chip: 452.5-455.0 nm):

10% phosphor (Sr_{1.95}Eu_{0.05}Si₅N_{7.95}F_{0.15}YF is modified phosphor-resin complex; BR101A-YF and BR102C-YF are reference phosphor-resin complexes).

FIG. 17 shows comparison of luminous properties when yellow YAG and red phosphor (Sr_{1.95}Eu_{0.05}Si₅N_{7.95}F_{0.15}) were applied to a LED PKG on a blue chip (450˜452.5 nm). [Comparative samples (BR102C), SY-LESI3: 00902: BR-101; 10: 10: 2.8: 0.125, Sr_{1.95}Eu_{0.05}Si₅N_{7.95}F_{0.15}, SY-LESI3: 00902: SSN-47; 10: 10: 2.8: 0.06]

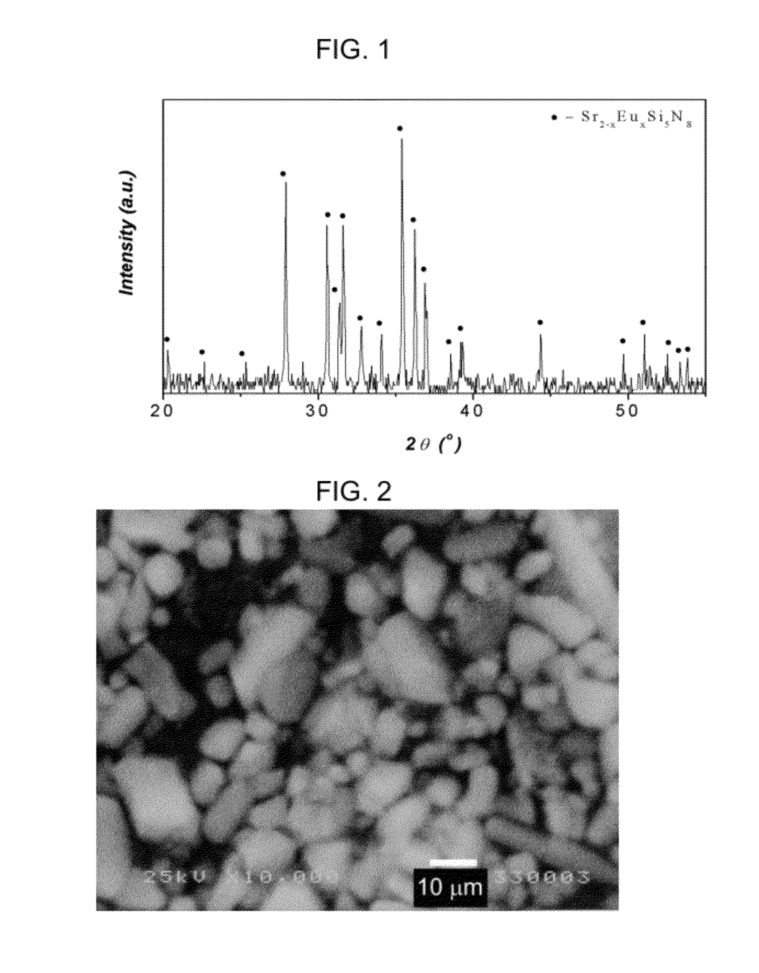

### BEST MODE

Hereinafter, the process for preparing nitride phosphor according to the invention, and application of the phosphor to light emitting devices will be described in detail with reference to Examples, which are given for illustration, not for restriction by any means.

Crystal structure and surface morphology of phosphore were determined by using a X-ray diffractometer with Cu Ka•radiation (Siemens D5000, Germany), and a scanning electron microscope (SEM; JSM 5410, JEOL, Japan). Particle size of the phosphor powder was determined by using a Malvern M 7 UK particle size analyzer according to laser particle size analysis (LPSA).

Photoluminescence analysis (PL) of the phosphor powder was evaluated by the characteristics of LED after depositing 5˜10% of phosphor powder mixed with resin on an InGaN layer.

Fluorescence spectrum was recorded on a fluorescence spectrophotometer (F-7000, Hitachi, Japan) using a Xe lamp with an excitation wavelength of 450 nm.

Photoluminescence (PL) spectrum of phosphor powder was recorded on a fluorescence spectrophotometer (F-7000, Hitachi, Japan) using a Xe lamp with an excitation wavelength of 450 nm.

Fluorine concentration (wt %) in phosphor powder was measured by SEA 5120 Fluorescence X-ray Element Monitor (Seiko

Instruments Inc.). Specific characteristics of the phosphors prepared are shown in Table 1.

### EXAMPLE 1

In a polymer bottle containing zirconia balls, 52.8 g strontium chloride (SrCl₂), 47.6 g of sodium azide (NaN₃), 18.6 g of silicon powder (Si) and 1.2 g of europium oxide (Eu₂O₃) were mixed at a rotation speed (ω=150 rotation/minute) for 2 hours.

Then the reaction mixture was filled into a paper cup of 4.0 cm in diameter to form a pellet. The experimental density of the pellet was 1.0 g/cm³.

Ignition for the combustion process was achieved by heating the nickel-chromium coil under high-purity nitrogen at a pressure of 2.0 MPa. When the combustion process was completed, the reaction mixture was cooled to ambient temperature.

The surface layer (2 mm in thickness) of the reaction product was eliminated, and the remaining part of the pellet was grinded, and poured into a 500 ml beaker in order to eliminate the reaction by-product and enhance the purity of the product.

For purification, the phosphor thus obtained was washed with hot distilled water to wash off NaCl formed as by-product. Then the phosphor was washed twice with acidified distilled water (diluted in a ratio of HCl:H₂O (w/w)=1:5). In order to remove the acid components, a small amount of NaOH solution was added to the beaker, thereby neutralizing the solution.

Then the nitride phosphor powder was washed several times with distillated water and dried at 70-90° C. for 10 hours or more.

The crystal structure and morphology of Sr_{1.95}Eu_{0.05}Si₅N₈ phosphor were characterized by an X-ray diffractometer with Cu Ka• radiation (Siemens D5000, Germany), and a scanning electron microscope (SEM; JSM 5410, JEOL, Japan). Photoluminescence analysis (PL) of the phosphor powder was performed on a fluorescence spectrophotometer (F-7000, Hitachi, Japan) using a Xe lamp with excitation wavelength of 355 nm.

The phosphor composition was confirmed to be pure Sr_{1.95}Eu_{0.05}Si₅N₈, and the particle size of the phosphor powder was not more than 10.0 μm (FIG. 2). The LED PKG light emitting intensity was 102%, being slightly higher than the comparative sample (BR102C) as shown in Table 1.

### EXAMPLE 2

A same procedure was carried out as described in Example 1, but the reaction mixture was prepared by using 52.8 g of strontium chloride (SrCl₂), 47.6 g of sodium azide (NaN₃), 18.6 g of silicon powder (Si), 1.2 g of europium oxide (Eu₂O₃) and 2.25 g of Na₂SiF₆.

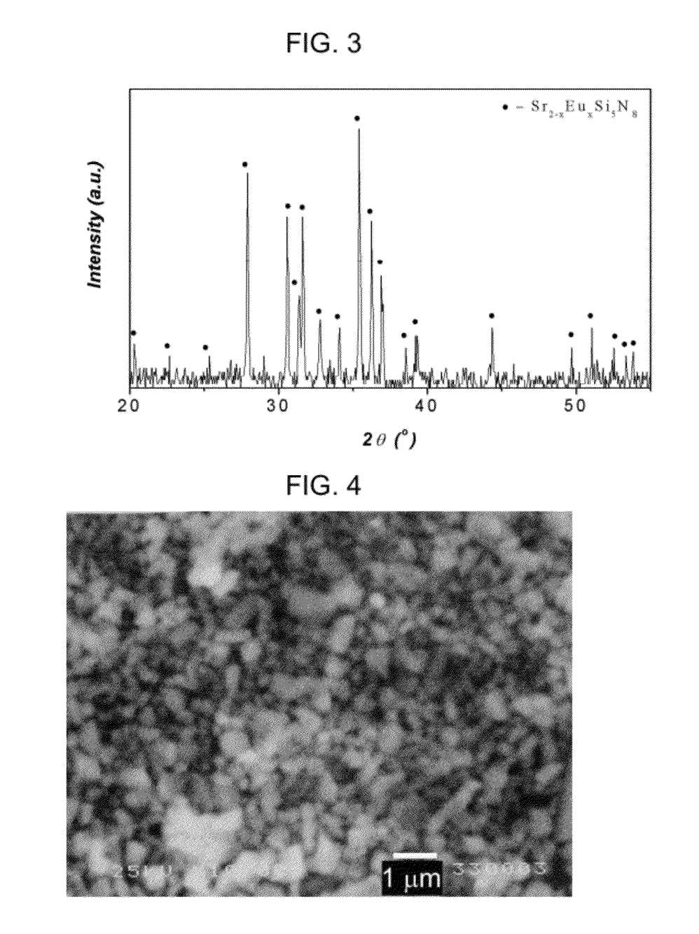

The resultant fluorine-containing phosphor was confirmed to have the composition of Sr_{1.95}Eu_{0.05}Si₅N_{7.95}F_{0.15} (FIG. 3), and particle size of the phosphor powder was not more than 1.0 μm (FIG. 4). It is found that addition of fluoride ion during the reaction results in reduction of size of the final phosphor. The LED PKG light emitting intensity was 117%, being higher than the comparative sample (BR102C) as shown in Table 1.

### EXAMPLE 3

A same procedure was carried out as described in Example 1, but the reaction mixture was prepared by using 52.8 g of strontium chloride (SrCl₂), 47.6 g of sodium azide (NaN₃), 18.6 g of silicon powder (Si), 2.0 g of europium oxide (Eu₂O₃) and 2.2 g of AlF₃.

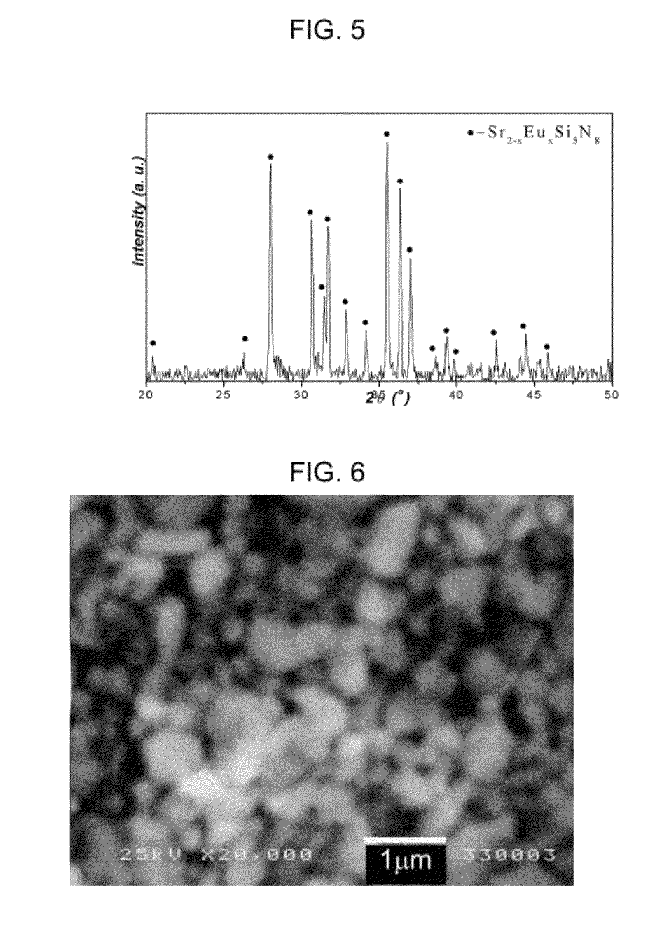

The resultant fluorine-containing phosphor was confirmed to have the composition of Sr_{1.92}Eu_{0.08}Si₅N_{7.95}F_{0.15} (FIG. 5), and particle size of the phosphor powder was not more than 1.0 μm (FIG. 6). It is found that addition of fluoride ion during the reaction results in reduction of size of the final phosphor. The LED PKG light emitting intensity was 115%, being higher than the comparative sample (BR102C) as shown in Table 1.

### EXAMPLE 4

A same procedure was carried out as described in Example 1, but the reaction mixture was prepared by using 52.8 g of strontium chloride (SrCl₂), 47.6 g of sodium azide (NaN₃), 18.6 g of silicon powder (Si), 4.8 g of europium oxide (Eu₂O₃) and 2.25 g of Na₂SiF₆.

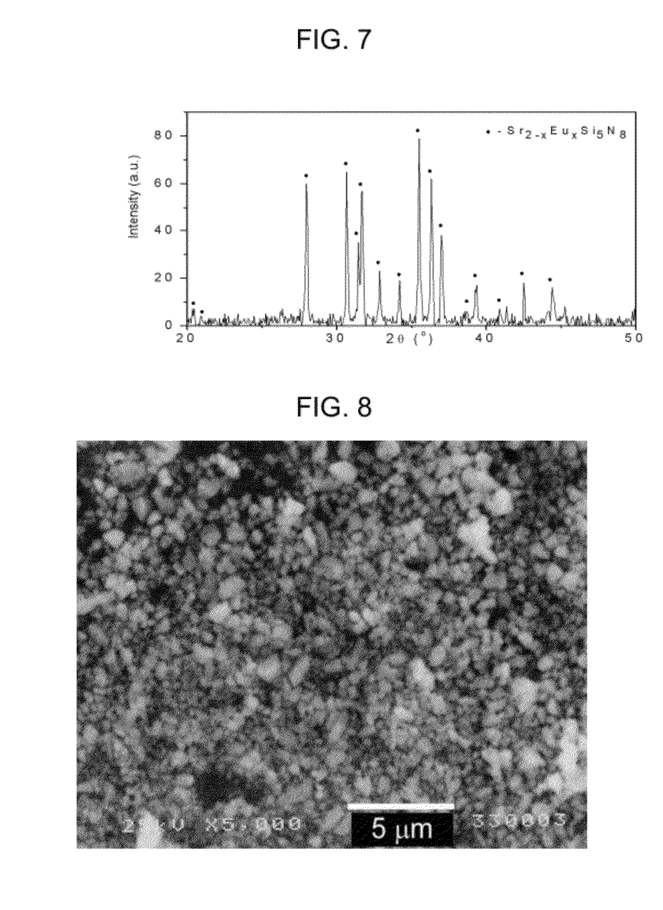

The resultant fluorine-containing phosphor was confirmed to have the composition of Sr_{1.8}Eu_{0.2}Si₅N_{7.95}F_{0.15} (FIG. 7), and particle size of the phosphor powder was not more than 1.0 μm (FIG. 8). It is found that addition of fluoride ion results in reduction of size of the final phosphor. The LED PKG light emitting intensity was 105%, being slightly higher than the comparative sample (BR102C) as shown in Table 1.

### EXAMPLE 5

A same procedure was carried out as described in Example 1, but the reaction mixture was prepared by using 44.5 g of calcium chloride (CaCl₂), 52 g of sodium azide (NaN₃), 27.5 g of silicon powder (Si), 1.35 g of europium oxide (Eu₂O₃) and 1.9 g of Na₂SiF₆.

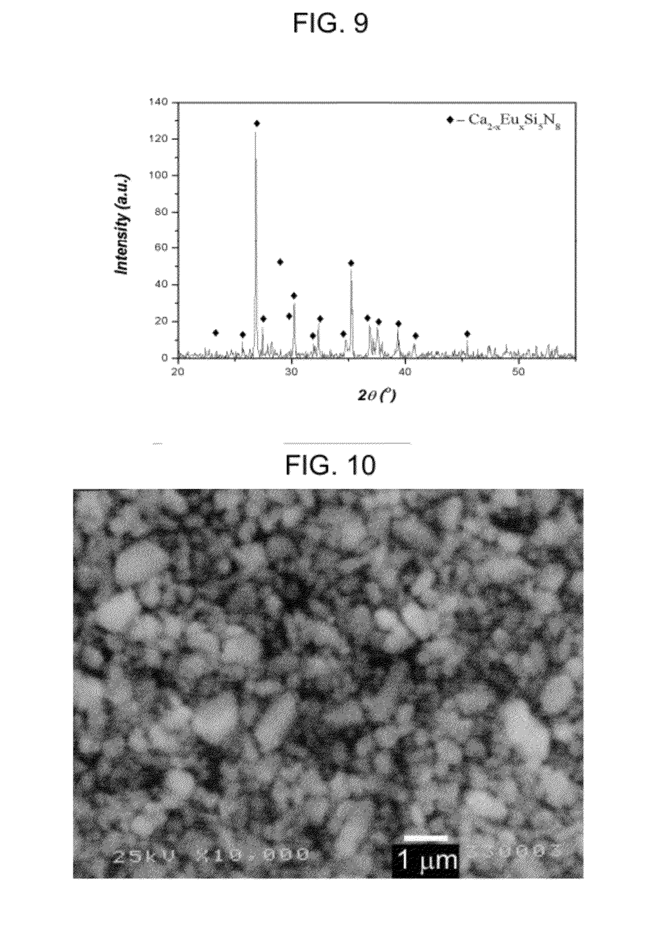

The resultant fluorine-containing phosphor was confirmed to have the composition of Ca_{1.95}Eu_{0.05}Si₅N_{7.95}F_{0.15} showing monophase calcium silicon-nitride pattern (FIG. 9), and particle size of the phosphor powder was not more than 1.0 μm (FIG. 10). It is also found that addition of fluoride ion results in reduction of size of the final phosphor. The LED PKG light emitting intensity was 93%, being rather decreased as compared to the comparative sample (BR102C).

### EXAMPLE 6

A same procedure was carried out as described in Example 1, but the reaction mixture was prepared by using 52.05 g of barium chloride (BaCl₂), 35.7 g of sodium azide (NaN₃), 14.0 g of silicon powder (Si), 0.9 g of europium oxide (Eu₂O₃) and 1.9 g of AlF₃.

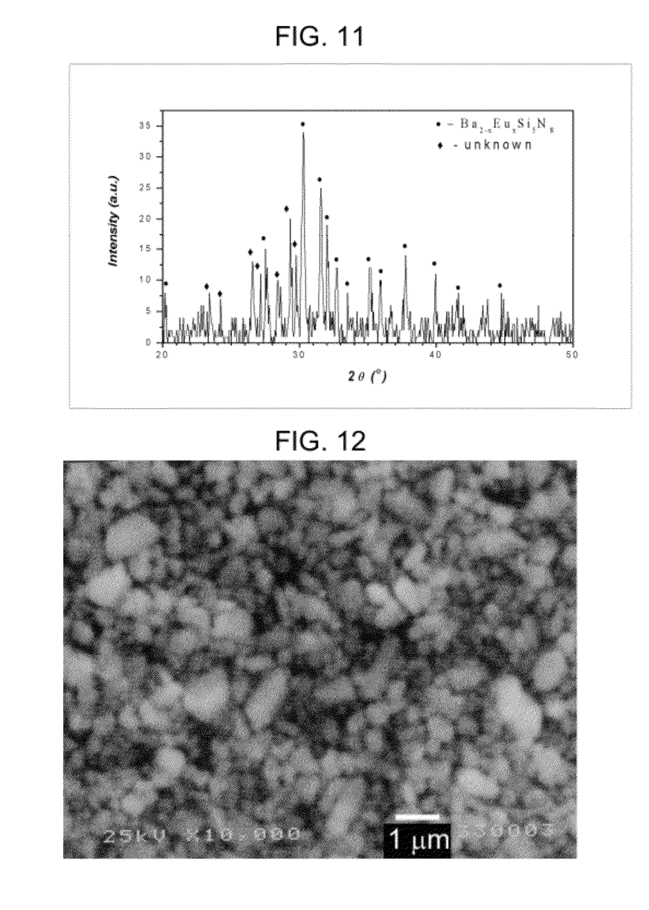

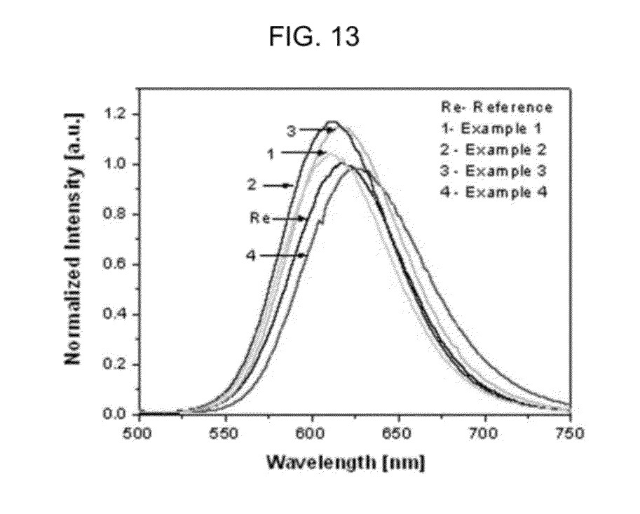

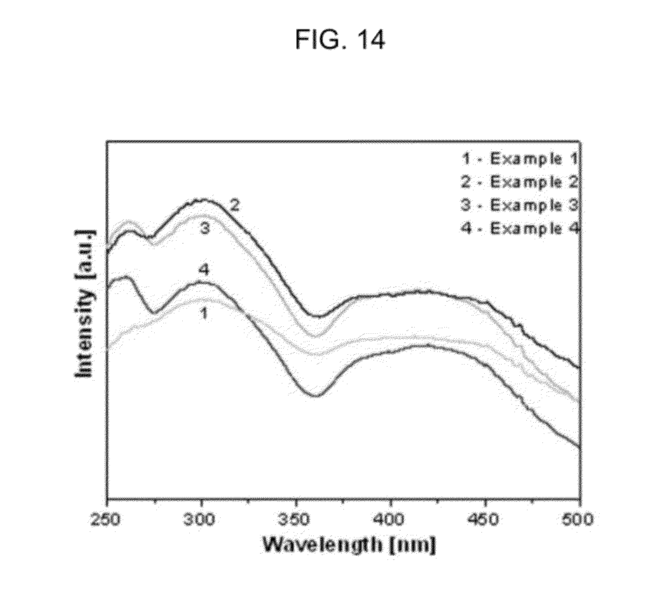

The resultant fluorine-containing phosphor was confirmed to have the composition of Ba_{1.95}Eu_{0.05}Si₅N_{7.95}F_{0.15} (FIG. 11), and particle size of the phosphor powder was not more than 1.0 μm (FIG. 12). It is also found that addition of fluoride ion during the reaction results in reduction of size of the final phosphor. The LED PKG light emitting intensity was 80%, being rather decreased as compared to the comparative sample (BR102C).

### EXAMPLE 7

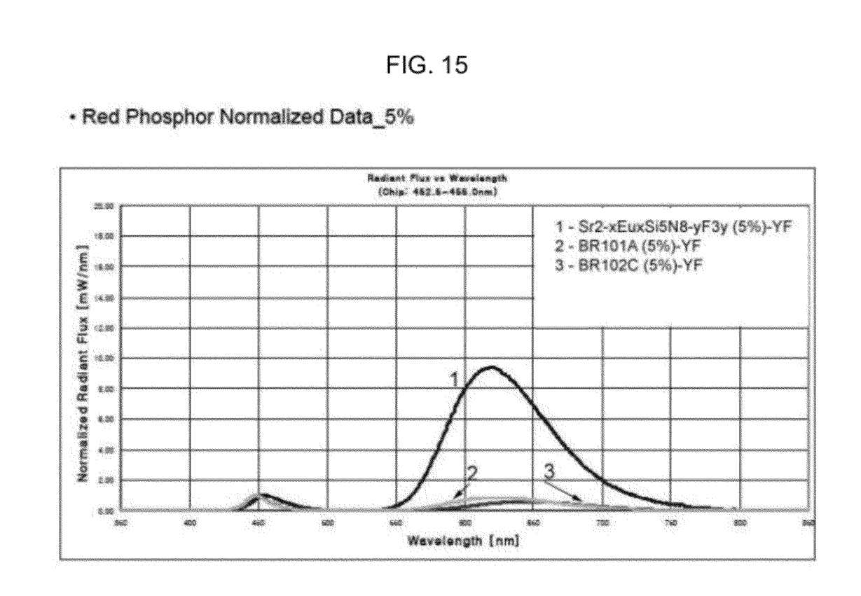

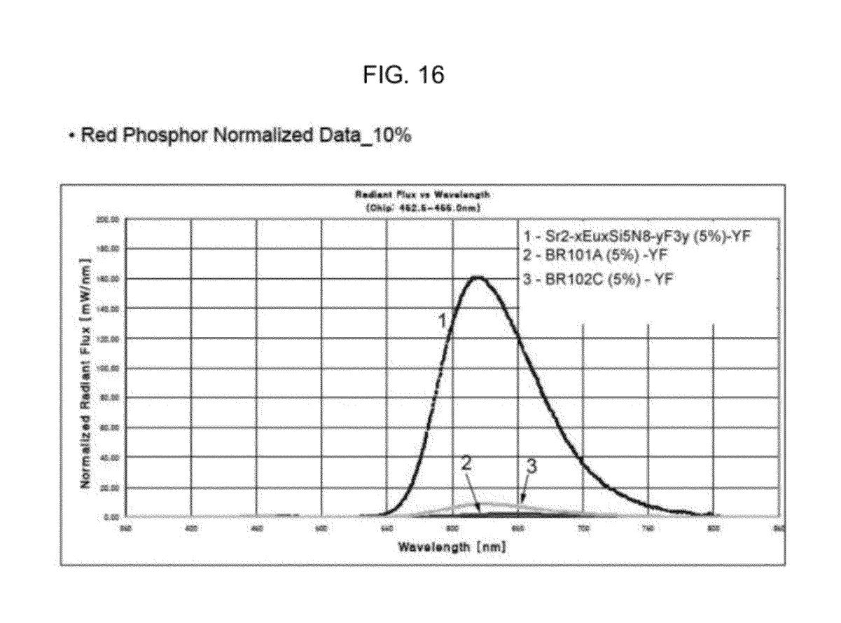

The red phosphor prepared according to the same procedure as described in Example 2, was packaged on a blue chip (wavelength: 452.˜455.0 nm) in a specific amount, and the normalized radian flux vs wavelength was compared to reference samples (BR101A-YF and BR102C-YF). The results are shown in FIG. 15 (amount of red phosphor added: 5%) and FIG. 16 (amount of red phosphor added: 10%). As can be seen from the figures, the product of the invention exhibits at least 10 times (or several dozens of times at most) of light emitting intensity as compared to the reference samples, being highly effective and applicable to LED's.

### EXAMPLE 8

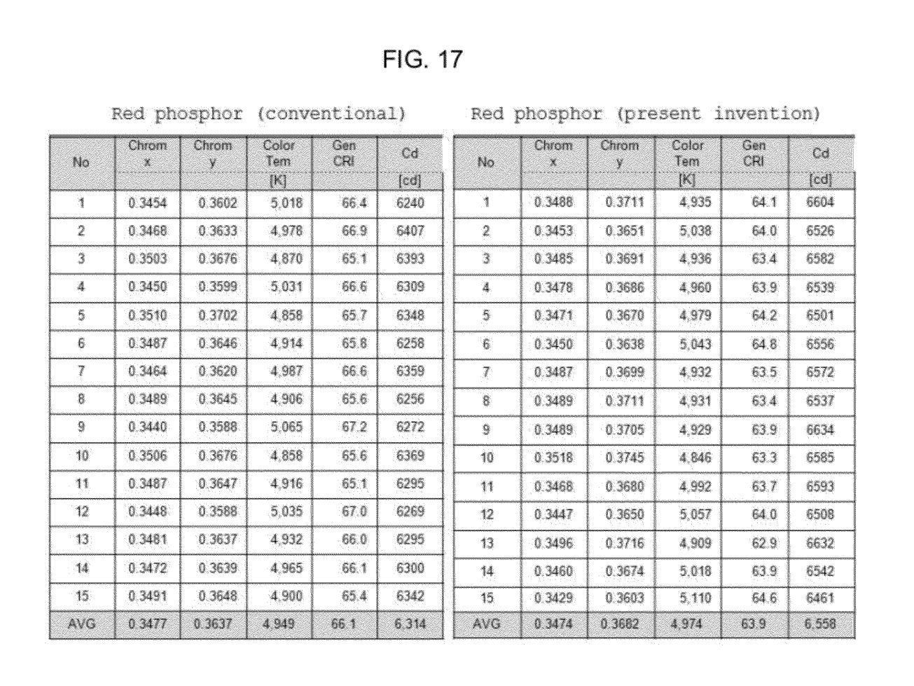

The red phosphor prepared according to the procedure described in Example 2 for the purpose of LED application (BLU: Back Light Unit) was packaged on a blue chip (wavelength: 450˜452.5 nm), and the luminescent properties were compared with reference sample (BR102C), which are listed in FIG. 17. The composition ratio of main component, curing agent, yellow phosphor YAG and red phosphor Sr_{1.95}Eu_{0.05}Si₅N_{7.95}F_{0.15} was as follows: (comparative sample BR102C), SY-LESI3: 00902: BR-101; 10: 10: 2.8: 0.125, (the inventive product Sr_{1.95}Eu_{0.05}Si₅N_{7.95}F₀₁₅), SY-LESI3: 00902: SSN-47; 10: 10: 2.8: 0.06. As can be seen from the figure, when the red phosphor according to the invention is added only in an amount of 48% on the basis of the comparative sample (reference sample: the inventive product: 0.125: 0.06) with maintaining the same composition ratio of the main component, curing agent and yellow phosphor YAG (10:10:2.8), equivalent color coordinate and slope can be realized, and light emitting intensity of a LED product increases by about 4%. Therefore, it is noticed that the product gives noticeable cost reduction with respect to the weight in mass production.

TABLE 1
Optical properties of silicon nitride phosphors

| | Int., | | BAND- | CIE- | CIE- | D | F⁻, |
|---|---|---|---|---|---|---|---|
| Name | (%) | DWL | W | x | y | (mm) | wt % |
| Reference | 100 | 619 | 76 | 0.618 | 0.376 | 8.2 | 0 |
| (BR102C) | | | | | | | |
| Example 1 | 102 | 613 | 75 | 0.611 | 0.373 | 2.0 | 0 |
| Example 2 | 117 | 613 | 72 | 0.612 | 0.369 | 2.0 | 0.7 |
| Example 3 | 115 | 619 | 77 | 0.618 | 0.375 | 2.0 | 0.8 |
| Example 4 | 105 | 627 | 84 | 0.625 | 0.380 | 2.0 | 0.75 |

Int. % is relative emission intensity of Sr_{1.95}Eu_{0.05}Si₅N₈ phosphor powder compared with reference sample (BR102C);
DWL is dominant wavelength;
BAND-W is emission band width;
CIE-x and CIE-y are color coordinates;
D is particle diameter;
F⁻ is fluorine weight concentration.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

The silicon nitride based phosphors according to the present invention, having small particle size, large surface area and improved chemical properties, can strongly absorb UV and blue light and efficiently convert it into orange-red light, so that they can be used as an effective phosphor to form a smooth layer without sedimentation in a LED package, and as light sources and displays.

1. A nitride phosphor represented by the following chemical formula:
Me₂₋ₓRₓSi₅N_{8-y}F_{3y}
wherein, Me represents alkaline earth metal, R represents rare earth metal, Si represents silicon element, and N represents nitrogen element, F represents fluorine element, and x and y are numbers satisfying 0<x<1 and 0≦y<0.5.

2. A nitride phosphor according to claim 1, wherein number x satisfies 0<x<1.0.

3. A nitride phosphor according to claim 1, wherein number y satisfies 0<y<0.5.

4. A nitride phosphor according to claim 1, wherein numbers x and y satisfy 0<x<0.5 and 0<y<0.3.

5. (canceled)

6. A process for preparing nitride phosphor having the composition of Me₂₋ₓRₓSi₅N₈ (0<x<1), which comprises
providing a reaction mixture comprising rare-earth metal compound, alkaline-earth metal salt, alkali metal azide, silicon source and nitrogen;
carrying out a self-operating combustion process of the reaction mixture in a high pressure reactor under nitrogen atmosphere; and
isolating the nitride phosphor produced through the combustion process and cleanse it.

7. A process for preparing nitride phosphor according to claim 6, wherein a fluorine source containing inorganic fluoride salt is additionally incorporated to the reaction mixture during the stage a) of providing the reaction mixture, in order to give the composition of Me₂₋ₓRₓSi₅N_{8-y}F_{3y} (0<x<1, 0≦y<0.5).

8. (canceled)

9. A process for preparing nitride phosphor according to claim 6, wherein the alkaline earth metal salt is selected from MgF₂, CaF₂, BaF₂, SrF₂, MgCl₂, CaCl₂, BaCl₂, SrCl₂, MgBr₂, CaBr₂, BaBr₂, SrBr₂, MgI₂, CaI₂, BaI₂ and SrI₂

10. A process for preparing nitride phosphor according to claim 6, wherein the molar ratio of alkaline earth metal salt to silicon source (Si) ranges from 2 to 3.5.

11. A process for preparing nitride phosphor according to claim 6, wherein alkali metal azide is selected from NaN₃, KN₃ and LiN₃.

12. A process for preparing nitride phosphor according to claim 6, wherein the molar ratio of alkaline earth metal salt (MX₂) to alkali metal azide (AN₃) ranges from 2:4 to 3.5:7.

13. A process for preparing nitride phosphor according to claim 7, wherein the fluorine source containing inorganic fluoride salt is at least one fluoride of an element selected from Group 1, 2 and 3 of the Periodic Table of elements, or it is selected from NaF, Na₂SiF₆, CaF₂, NH₄F and AlF₃.

14. A process for preparing nitride phosphor according to claim 6, wherein the rare earth metal compound is selected from Y, La, Ce, Pr, Nd, Sm, Eu, Gd, Tb, Dy, Ho, Er and Lu.

15. A process for preparing nitride phosphor according to claim 6, wherein the molar ratio of rare earth metal compound to alkaline earth metal salt ranges from 0.02 to 1.

16. (canceled)

17. (canceled)

18. (canceled)

19. (canceled)

20. A light emitting device comprising nitride phosphor according to claim 1.

21. A LED package comprising nitride phosphor according to claim 1.

22. A LED package according to claim 21, wherein the yellow phosphor and red nitride phosphor are provided on a blue chip (450˜470 nm).
